(19) United States
(12) Patent Application Publication
(10) Pub. No.: US 2026/0326420 A1
(43) Pub. Date: Oct. 22, 2026

(54) ACOUSTICALLY INSULATING LAMINATED GLAZING COMPRISING AN INTERLAYER MADE UP OF TWO EXTERNAL LAYERS BASED ON AN ETHYLENE-CARBOXYLIC ACID COPOLYMER AND AN ADHESIVE INTERNAL LAYER BASED ON LATEX, A PLASTICIZER AND A TACKIFIER

(71) Applicant: SAINT-GOBAIN SEKURIT FRANCE, THOUROTTE (FR)

(72) Inventors: Ahmed ABBAD, COURBEVOIE (FR); Gérald MERCIER, COURBEVOIE (FR)

(21) Appl. No.: 19/116,859

(22) PCT Filed: Sep. 29, 2023
(86) PCT No.: PCT/FR2023/051504

§ 371 Date: Mar. 28, 2025

(30) Foreign Application Priority Data
Sep. 30, 2022 (FR) FR2209964

(51) Int. Cl. B32B 17/10

(52) U.S. Cl. CPC B32B 17/10036; B32B 17/10743; B32B 17/10779; B32B 17/10788; B32B 17/1099; B32B 2250/05; B32B 2307/51; B32B 2307/7376; B32B 2419/00; B32B 2605/00

(57) ABSTRACT

A laminated glazing includes an inner and outer glass sheets, each including an inner face and an outer face, and including, between the inner faces of the two glass sheets, an interlayer, which includes at least two viscoelastic outer layers and having a thickness of between 0.1 mm and 0.8 mm, each of the two outer layers being in direct contact with one of the two glass sheets and being formed by a material including at least one ethylene-carboxylic acid copolymer-based ionomer, and a viscoelastic damping adhesive inner layer, arranged between the two outer layers and, the viscoelastic damping adhesive layer having a thickness of between 15 μm and 25 μm and being formed by a material including at least one acrylic polymer, at least one tackifier and at least one plasticizer.

The present invention relates to a laminated glazing having good mechanical properties for damping vibrations and/or increasing loss of noise transmission, particularly of airborne origin, notably in the audible frequency decade between 1 kHz and 10 kHz at room temperature, as well as a method for manufacturing said laminated glazing. In particular, the laminated glazing may be a side window or a windshield of a vehicle.

It is know to use tempered monolithic glazing for acoustic insulation in vehicles or buildings, and more particularly for the side windows of motor vehicles. However, such glazing shows significant transmission of airborne noise caused by air flow turbulence on said glazing. Furthermore, in the case of this tempered monolithic glazing, the improvement in acoustic insulation is generally accompanied by an increase in the thickness of the glass; which poses a particular problem in the field of automotive glazing due to today's demand for lighter vehicles.

To solve this problem, thin glazing can be laminated with a viscoelastic interlayer composed of a polyvinyl butyral (PVB)-based material, better known as acoustic PVB. To this end, document EP2608958 describes laminated glazing having vibration-damping properties which are composed of a first glass sheet and a second glass sheet of low thicknesses, with a viscoelastic interlayer therebetween. The interlayer is a three-layer interlayer comprising two layers of PVB, also known as “outer layers” or “skins”, assembled by means of a layer of PVB including plasticizers, also known as an “inner layer” or “core”. In this type of interlayer, the inner layer has higher vibration-damping properties than the two outer layers. Additionally, such laminated glazing offers higher acoustic insulation performance than that of tempered monolithic glazing, for equivalent glass thicknesses. However, such laminated glazing has less mechanical rigidity than tempered monolithic glazing.

In fact, improving the mechanical strength of glazing for buildings or motor vehicles, combined with reducing glass thicknesses and good acoustic insulation, are generally not compatible with each other.

The Applicant therefore sought to provide thin laminated glazing, having improved acoustic insulation, in particular to airborne sound in the frequency decade between 1 kHz and 10 kHz at room temperature (or an increase in acoustic attenuation), and good mechanical properties, such as good mechanical strength (for example, rigidity, shear stress, etc.).

The Applicant has thus developed a laminated glazing comprising an inner glass sheet (1) and an outer glass sheet (2), each comprising an inner face and an outer face, and comprising, between the inner faces of the two glass sheets, an interlayer (3), characterized in that said interlayer comprises:
at least two viscoelastic outer layers (4) and (5) having a thickness of between 0.1 mm and 0.8 mm, each of the two outer layers being in direct contact with one of the two glass sheets and being formed by a material comprising at least one ethylene-carboxylic acid copolymer-based ionomer, and
a viscoelastic damping adhesive inner layer (6), arranged between the two outer layers (4) and (5), said viscoelastic damping adhesive layer having a thickness of between 15 μm and 25 μm and being formed by a material comprising at least one acrylic polymer, at least one tackifier and at least one plasticizer.

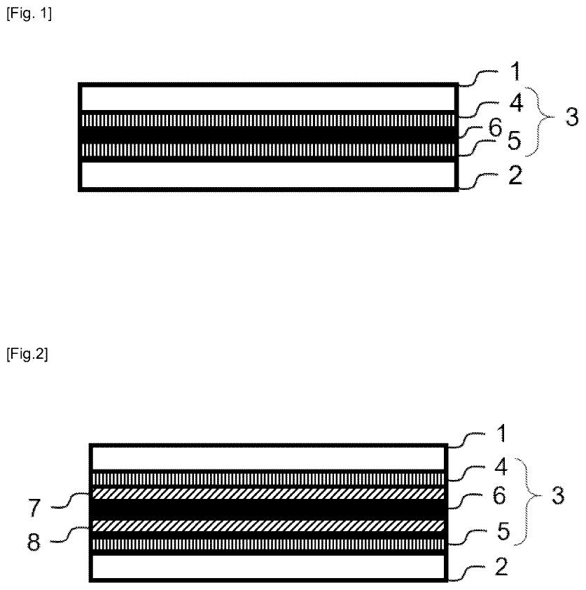

FIG. 1—FIG. 1 schematically shows a detail of a cross-section of a laminated glazing according to one embodiment of the invention.

Indeed, it was surprisingly found by the inventors that the combination in the interlayer of: two outer layers formed by a particular material comprising at least one ethylene-carboxylic acid copolymer-based ionomer and having a thickness of between 0.1 mm and 0.8 mm with an inner layer having a specific thickness of between 15 μm and 25 μm and formed by a particular acrylic polymer-based material, tackifier and plasticizer (as defined in the present application), allowed laminated glazing to be obtained having improved acoustic insulation performance (more particularly high airborne acoustic attenuation properties) and good mechanical properties (more particularly high mechanical strength).

This improvement in the airborne acoustic insulation of glazing obtained according to the invention is due to a loss factor: tan o (determined by dynamic mechanical analysis) of the three-layer interlayer whose value is greater than or equal to 2, preferably greater than or equal to 3, over the frequency decade between 1 Hz and 10 kHz, preferably over the frequency interval between 1 kHz and 10 kHz, for a temperature range between 0° C. and 40° C., preferably between 10° C. and 30° C., more preferentially between 15° C. and 25° C. and even more preferentially for a temperature close to or equal to 20° C.

Thus, the inventors have demonstrated that the implementation of an interlayer which has a high loss factor tan δ and which therefore comprises:
two outer layers based on an ethylene-carboxylic acid copolymer with a thickness of between 0.1 mm and 0.8 mm, preferably between 0.15 mm and 0.5 mm, preferentially between 0.2 mm and 0.4 mm and more preferentially equal to 0.38 mm, and
an inner layer formed by a particular material based on acrylic polymer, a tackifier and a plasticizer and having a specific thickness of between 15 μm and 25 μm, further enhances the acoustic insulation performance of the glazing fitted therewith.

The loss factor tan δ of a material corresponds to the ratio between the energy dissipated as heat and the elastic deformation energy. It therefore corresponds to a technical characteristic specific to the nature of a material and translates its capacity to dissipate energy, in particular acoustic waves. The higher the loss factor, the greater the energy dissipated, and therefore the more the material performs its vibration-damping role. This loss factor tan δ varies depending on the temperature and frequency of the incident wave. For a given frequency, the loss factor reaches its maximum value at a temperature, referred to as the glass transition temperature determined by dynamic mechanical analysis. This loss factor tan δ can be estimated using a rheometer or any other suitable known device. The rheometer is an apparatus that enables a sample of material to be subjected to deformation stresses under precise temperature and frequency conditions, and thereby to obtain and process the set of rheological quantities that characterize the material. More specifically, the loss factor is measured using a rotary rheometer in oscillation mode, where the sample is subjected to a sinusoidal stress for angular velocities ω of 1 to 1000 rad/s in a temperature range from −100° C. to 100° C. with increments every 5° C. The rheometer used by the Applicant is the MCR 302 model from Anton Paar.

According to the invention, the laminated glazing is composed of a first inner glass sheet (1) and a second outer glass sheet (2), between which there is an interlayer (3).

According to the invention, “inner glass sheet” means a glass sheet facing the interior of the vehicle or building. An “outer glass sheet”, in this application, means a glass sheet facing the exterior environment.

Each glass sheet has an inner and an outer face. Between the inner surfaces of the two glass sheets (1, 2) is the interlayer (3).

The inner and outer glass sheets (1, 2) are preferably made of soda-lime glass, as is usual for windows. However, the glass sheets can also be made of other types of glass, e.g. quartz glass, borosilicate glass or aluminosilicate glass, or in rigid transparent plastics, e.g. polycarbonate or polymethylmethacrylate. The thickness of the inner glass sheet and the outer glass sheets can vary and thus be adapted to the various requirements. The inner glass sheet and/or the outer glass sheet preferably have a thickness of between 0.5 mm and 12 mm and preferentially between 1.1 mm and 3 mm.

According to a preferred embodiment, the inner and/or the outer glass sheet comprises at least one coating. This (these) coating(s) is (are) intended to give the glass substrate: optical properties (mirrored or anti-reflective layers), thermal properties (low-emissive layers, solar control or anti-solar layers) or electrical properties (transparent conductive layers, antistatic layers). The inner glass sheet and/or outer glass sheet may also include other types of coatings, such as non-stick coatings, scratch-resistant coatings, or photocatalytic coatings.

Another possibility is that the inner glass sheet and/or the outer glass sheet can be tinted, thus featuring one or more layers of metal oxide coating, providing the glazing with various thermal or aesthetic functions. Additionally, the inner glass sheet and/or the outer glass sheet may be thermally or chemically tempered (such as the IOX or Gorilla Glass types marketed by Corning) and/or feature electrochromic functions for controlling and varying the light transmission (TL) of said glazing.

The interlayer (3) is arranged between the first and second glass sheets, i.e. between the inner glass sheet (1) and the outer glass sheet (2), as defined above, and more precisely between the inner faces of the two glass sheets (1, 2). The interlayer according to the invention comprises at least two viscoelastic outer layers (4) and (5), each being in direct contact with one of the two glass sheets and having a thickness of between 0.1 mm and 0.8 mm, the two outer layers being formed by a material comprising at least one ethylene-carboxylic acid copolymer-based ionomer, said outer layers also being referred to as “skin layers”. Said outer layers (4) and (5) are assembled by means of a viscoelastic damping adhesive inner layer (6), and are defined below.

The two viscoelastic outer layers (4) and (5), according to the invention, have a thickness of between 0.1 mm and 0.8 mm, preferably between 0.15 mm and 0.5 mm, preferentially between 0.2 mm and 0.4 mm, and more preferentially the thickness is equal to 0.38 mm.

These two outer layers notably ensure that the viscoelastic interlayer, sandwiched between the two glass sheets, has a sufficiently high shear modulus (G′); in other words, that the glazing is sufficiently stiff. The shear modulus G′ can be linked, notably for an isotropic material, to the Young's modulus E′ by the relationship G′=E′/2(1+v), wherein v is the Poisson's factor of the material.

Each of these two outer layers (4) and (5) is in direct contact with one of the two glass sheets (1) or (2). The two outer layers are formed by a material comprising at least one ethylene-carboxylic acid copolymer-based ionomer. Preferably, the ionomer is a copolymer comprising at least one ethylene monomer and at least one α-β-unsaturated carboxylic acid monomer and 1% to 100% of the acid groups of said copolymer are neutralized to carboxylic acid salts comprising carboxylate ions and metal counterions. The metal counterion may consist substantially in a zinc ion. Advantageously, 15% to 45% of the acid groups of said copolymer are neutralized, and even more advantageously 25% to 40%.

And more particularly, said copolymer has from 12% to 30% of a carboxylic acid monomer selected from acids in the group consisting of α-β-unsaturated acids having 3 to 8 carbon atoms. Even more particularly, the copolymer has 17% to 23% of a carboxylic acid monomer.

Carboxylic acids, which can be used as a monomer for the copolymer described hereinbefore, are selected in the group consisting of acrylic acid, methacrylic acid, itaconic acid, maleic acid, maleic anhydride, fumaric acid, maleic acid monomethyl ester and mixtures thereof. Functional equivalents of carboxylic acids known to a person skilled in the art can also be used such as carboxylate salts, anhydrides, esters, acyl halides, amides, nitriles and similar compounds which can be converted to carboxylic acids or in acid salts by hydrolysis.

In the present invention, it is for example possible to use as ethylene carboxylic acid-based ionomer resins, those described in the following patent applications: WO 2004/011755, WO 2006/057771 and WO 2007/064794. In particular, it is possible to use layers marketed by the Dupont de Nemours company called SentryGlass® as viscoelastic outer layers.

The viscoelastic damping adhesive inner layer (6), according to the invention, is arranged between the two outer layers (4) and (5), and has a thickness of between 15 μm and 25 μm, preferably the thickness is equal to 25 μm and said inner layer is formed by a material comprising at least one acrylic polymer, at least one tackifier and at least one plasticizer.

Surprisingly, the inventors found that the thickness of the viscoelastic damping adhesive inner layer (6) arranged between the two outer layers (4) and (5) had to be between 15 μm and 25 μm in order to achieve better acoustic insulation of the laminated glazing.

As a result, the inner layer (6) according to the invention is used to bond together the two outer layers (4) and (5) of the interlayer (3) and ensure the structural adhesion of the two glass sheets in the laminated glazing, after drying and calendering, then this said inner layer is used to dampen vibrations and/or increase the loss of noise transmission, in particular of airborne origin, over the frequency decade between 1 kHz and 10 kHz, at room temperature. And the specific thickness of this inner layer ensures that the laminated glazing, according to the invention, has good acoustic properties.

Preferably, the inner layer (6) is positioned in the center of the interlayer (3), which is itself arranged between the first glass sheet and the second glass sheet (1, 2).

The material of the viscoelastic damping adhesive inner layer may have a glass transition temperature of between −55° C. and 10° C. inclusive, in particular between −45° C. and +5° C. and preferentially between −30° C. and −5° C.

According to the invention, the glass transition temperature (Tg) of the viscoelastic damping adhesive inner layer can be measured by differential scanning calorimetry (DSC) analysis. The glass transition temperature may be determined using the midpoint method as described in ASTM-D-3418 for differential scanning calorimetry. The measurement apparatus used by the applicant is the Discovery DSC model from TA Instruments.

Preferably, a glass transition temperature Tg is determined by dynamic mechanical analysis (DMA) or dynamic mechanical spectrometry. The value of Tg is determined by plotting an isofrequency curve of the loss factor as a function of material temperature. The temperature at which the value of the loss factor is maximum is equal to the glass transition temperature Tg. The glass transition temperature depends on the excitation frequency of the material. In the present application, “glass transition temperature” means the glass transition temperature measured at a frequency of 1 Hz by DMA.

As previously defined, the viscoelastic damping inner layer (6), according to the invention, is formed by a material comprising at least one acrylic polymer, at least one tackifier and at least one plasticizer.

The acrylic polymer(s) may be formed from monomers selected from the group formed by methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, pentyl acrylate, pentyl methacrylate, isoamyl acrylate, isoamyl methacrylate, hexyl acrylate, hexyl methacrylate, cyclohexyl acrylate, cyclohexyl methacrylate, octyl acrylate, octyl methacrylate, isooctyl acrylate, isooctyl methacrylate, nonyl acrylate, nonyl methacrylate, isononyl methacrylate, isobornyl methacrylate, decyl acrylate, decyl methacrylate, dodecyl acrylate, dodecyl methacrylate, tridecyl acrylate, tridecyl methacrylate, hexadecyl acrylate, hexadecyl methacrylate, octadecyl acrylate, octadecyl methacrylate, 2-ethylhexyl acrylate, 2-ethylhexyl methacrylate, vinyl formate, vinyl acetate, vinyl propionate, 2-hydroxyethyl acrylate, hydroxyethyl methacrylate, 2-hydroxypropyl acrylate, 2-hydroxypropyl methacrylate, acrylic acid, styrene and acrylonitrile.

The acrylic polymer(s) may be copolymers, formed from at least two monomers chosen from the group formed by the monomers defined previously.

Preferably, the inner layer may comprise two different acrylic polymers. Preferably, one of the two polymers is 2-ethylhexyl acrylate (2-EHA) and the other of the two polymers is butyl acrylate (BA). The mass ratio between 2-ethylhexyl acrylate (2-EHA) and butylacrylate (BA) may be between 2 and 4, and is preferentially equal to 3.

Other commercial latexes comprising an acrylic polymer can be used to form the inner layer (6). It is for example possible to use the Arkema® Encor 4028, Arkema® Encor 4517, or Alberdingk® A&B75070 latexes.

The material may comprise another polymer which is not an acrylic polymer. Such another polymer may be formed from at least one monomer selected from styrene and methyl methacrylate.

The material may comprise a first acrylic polymer having a first glass transition temperature Tg₁ and a second polymer, acrylic or non-acrylic, having a second glass transition temperature Tg₂, greater than Tg₁. The difference between the second glass transition temperature Tg₂ and between the first glass transition temperature Tg₁ is preferentially greater than 10° C., and preferentially greater than 20° C. Thus, it is possible to increase the glass transition temperature of the material with regard to the glass transition temperature of a material obtained only with the first acrylic polymer. Indeed, the glass transition temperature obtained only with the first acrylic polymer may be too low to have a maximum damping of the material in an audible frequency range.

The polymer(s) may form an interpenetrating polymer network (IPN). The polymer system of the interpenetrating polymer network (IPN) type can thus be used, in the present invention, to form the core of the three-layer interlayer (3).

The Applicant in particular proposes the use of a latex, that is, an aqueous emulsion of polymeric particles containing an IPN in order to form the inner layer of the three-layer interlayer, as defined in the present application. In the present application, “latex” is understood to mean a dispersion of polymeric particles in water or in an aqueous solvent. The latex may comprise polymeric particles having a core-shell structure. The core may be formed of an interpenetrating polymer network (IPN) having a glass transition temperature (Tg) comprised between −50° C. and −30° C., preferably between −45° C. and −35° C., and the shell can be formed of a polymer having a glass transition temperature that is low enough to allow the coalescence of the particles after drying. The glass transition temperature of the shell may be less than that of the core, and may preferably be less than −50° C., and more preferentially less than −60° C. The IPN thus comprises a first cross-linked polymer and a second polymer, which may or may not be cross-linked. In a preferred embodiment of the invention, the second polymer is non-cross-linked. In this case, the IPN is a so-called “semi-interpenetrated polymer” network (semi-IPN). The second polymer may be linear or branched.

In particular, the mass fraction of the acrylic polymer(s) in the viscoelastic damping adhesive inner layer (6) of the material is between 0.21 and 0.62, notably between 0.21 and 0.51, and preferentially between 0.21 and 0.35.

In the present application, “mass fraction” of a first element in a second element is understood to mean the ratio of the mass of the first element to the mass of the second element.

The addition of a tackifier and/or a plasticizer in at least one acrylic polymer provides a means of adhesion between the two viscoelastic outer layers.

The tackifier may be selected from natural tackifying resins, notably rosins and terpenes, and synthetic tackifying resins such as aliphatic or aromatic resins derived from petroleum. The tackifier may comprise a hydrogenated resin, and preferentially a hydrogenated rosin resin. The hydrogenated resin may comprise a glyceric ester of wood resin, preferably abietic acid. The hydrogenated resin may comprise a hydrogenated rosin ester (for example a resin of the brand Arakawa® KE-311 or KE-100 or FTE019 or FTE020).

In particular, the mass fraction of the tackifier(s) in the viscoelastic damping adhesive inner layer (6) is between 0.17 and 0.60, notably between 0.22 and 0.35, and preferentially between 0.22 and 0.26.

According to the invention, the plasticizer allows tooptimize the rheological properties of the composition of the viscoelastic damping adhesive inner layer in order to obtain the best acoustic performance for the glazing. The plasticizer may comprise at least one element selected from citrate, adipate, glycol and triethylene glycol derivative. The citrate may be acetyl-tributyl citrate. Adipate may be triethylene glycol bis (2-ethylhexanoate) (for example, sold under the name WVC 3800 by Celanese®).

In particular, the mass fraction of the plasticizer(s) in the viscoelastic damping adhesive inner layer (6) is between 0.07 and 0.43, notably between 0.12 and 0.31, and preferentially between 0.16 and 0.26.

Thus, advantageously, the material has a mass fraction of the acrylic polymer(s) in the viscoelastic damping adhesive inner layer (6) of between 0.21 and 0.62, a mass fraction of the plasticizer(s) in the inner layer (6) of between 0.07 and 0.43 and a mass fraction of the tackifier in the inner layer (6) of between 0.17 and 0.60.

Advantageously, the material has a mass fraction of the acrylic polymer(s) in the viscoelastic damping adhesive inner layer (6) of between 0.21 and 0.51, a mass fraction of the plasticizer(s) in the inner layer (6) of between 0.12 and 0.31 and a mass fraction of the tackifier(s) in the inner layer (6) of between 0.22 and 0.35.

Advantageously, the material has a mass fraction of the acrylic polymer(s) in the viscoelastic damping adhesive inner layer (6) of between 0.21 and 0.35, a mass fraction of the plasticizer(s) in the inner layer (6) of between 0.16 and 0.26 and a mass fraction of the tackifier(s) in the inner layer (6) of between 0.22 and 0.26.

Advantageously, the material has an mass fraction of the acrylic polymer(s) in the viscoelastic damping adhesive inner layer (6) of between 0.21 and 0.62, a mass fraction of the plasticizer(s) in the inner layer (6) of between 0.12 and 0.31 and a mass fraction of the tackifier(s) in the inner layer (6) of between 0.22 and 0.35.

Advantageously, the material has a mass fraction of the acrylic polymer(s) in the viscoelastic damping adhesive inner layer (6) of between 0.21 and 0.62, a mass fraction of the plasticizer(s) in the inner layer (6) of between 0.16 and 0.26 and a mass fraction of the tackifier(s) in the inner layer (6) of between 0.22 and 0.26.

According to a preferred embodiment of the invention, the interlayer (3) further comprises two films (7) and (8) made from a material selected from poly(ethylene vinyl acetate) (EVA) and poly(ethylene terephthalate) (PET) and mixtures thereof, each of the two films being arranged between the viscoelastic damping adhesive inner layer (6) and one of the two viscoelastic outer layers (4) or (5). Thus, preferentially the inner layer (6) is positioned in the center of the interlayer (3), which is itself arranged between the first glass sheet and the second glass sheet (1, 2). And advantageously, the two films (7) and (8) are in direct contact with the viscoelastic damping adhesive inner layer (6). And even more advantageously, the film (7) is also in direct contact with the viscoelastic outer layer (4) and the film (8) is also in direct contact with the viscoelastic outer layer (5). The thickness of each of the two films is preferably between 6 μm and 200 μm and more preferentially between 12 μm and 50 μm. Thus preferably, the interlayer (3) is made up of five layers, namely the adhesive inner layer (6), the films (7) and (8) and the viscoelastic outer layers (4) and (5).

The two films (7) and (8) have the advantage of preventing components of the inner layer from entering the outer layers and thus avoiding any chemical incompatibilities existing between the components of the inner layer and those of the outer layers of the interlayer.

FIG. 2—FIG. 2 schematically shows a detail of a cross-section of a laminated glazing according to a preferred embodiment of the invention as described hereinbefore.

Preferably, the layers (or films) between the inner glass sheet (1) and the inner layer (6) and the layers between said inner layer (6) and the outer glass sheet (2) are identical; in other words, they have the same chemical nature and thicknesses.

The invention also relates to a side window or a windshield of a vehicle comprising a laminated glazing as described previously.

The invention also relates to a method for manufacturing a laminated glazing as described hereinbefore comprising the following steps:
a) providing an inner glass sheet (1) and an outer glass sheet (2),
b) arranging between the inner faces of the two glass sheets (1, 2) an interlayer (3) comprising:
a first viscoelastic layer (4) formed by a material comprising at least one ethylene-carboxylic acid copolymer-based ionomer and having a thickness of between 0.1 mm and 0.8 mm,
a viscoelastic damping adhesive layer (6) formed by a material comprising at least one acrylic polymer, at least one tackifier and having a thickness of between 15 μm and 25 μm, and
a second viscoelastic layer (5) formed by a material comprising at least one ethylene-carboxylic acid copolymer-based ionomer and having a thickness of between 0.1 mm and 0.8 mm,
c) assembling the two glass sheets (1,2) and the interlayer (3) by lamination to form a laminated glazing, and
d) degassing by autoclaving said laminated glazing.

According to a preferred embodiment, the interlayer (3) is manufactured according to the method comprising the following steps:
supplying a first sheet made from a material comprising at least one ethylene-carboxylic acid copolymer-based ionomer and having a thickness of between 0.1 mm and 0.8 mm,
depositing on one of the faces of said first ethylene-carboxylic acid copolymer-based ionomer sheet, a liquid composition comprising a latex, a tackifier and a plasticizer, the latex comprising an emulsion, the emulsion comprising an aqueous continuous phase and a dispersed phase, the dispersed phase comprising at least one acrylic polymer,
drying said composition so as to form a viscoelastic damping adhesive layer having a thickness of between 15 μm and 25 μm,
applying to said adhesive layer thus formed of a second sheet made from a material comprising at least one ethylene-carboxylic acid copolymer-based ionomer and having a thickness of between 0.1 mm and 0.8 mm.

The liquid composition can be a dilution of the latex, of the tackifier and the plasticizer in an aqueous phase.

The step of depositing the liquid composition comprising a latex, a tackifier and a plasticizer on the first sheet made from a material comprising at least one ethylene-carboxylic acid copolymer-based ionomer and having a thickness of between 0.1 mm and 0.8 mm can be carried out by the known roll-to-roll liquid deposition method, more precisely by the nip-fed reverse roll liquid deposition method.

Furthermore, the drying step of said composition is preferably carried out continuously, at room temperature and/or in a furnace at a temperature comprised between 40° C. and 120° C., preferably between 60° C. and 100° C. Advantageously, this drying step is carried out under a reduced pressure comprised between 0.01 atm and 1 atm, preferentially between 0.1 atm and 0.5 atm, ideally at a pressure equal to 0.25 atm.

Preferably, the interlayer (3) further comprises two films (7) and (8) made from a material selected from poly(ethylene vinyl acetate) (EVA) and poly(ethylene terephthalate) (PET) and mixtures thereof, each of the two films being arranged between the viscoelastic damping adhesive inner layer (6) and one of the two viscoelastic outer layers (4) or (5), and each of the two films is advantageously in direct contact with the viscoelastic damping adhesive inner layer and/or one of the two viscoelastic outer layers. In this particularly preferred embodiment, the liquid composition comprising a latex, a tackifier and a plasticizer is then deposited on one of the faces of the first film made from a material selected from poly(ethylene vinyl acetate) (EVA) and poly(ethylene terephthalate) (PET) and mixtures thereof.

The parameters of the method such as the tension of the ethylene-carboxylic acid copolymer-based sheets and the stability of the rollers and the supply of the liquid composition by the slot can be controlled in such a way that the three-layer interlayer according to the invention does not have any ripple defects.

The invention also relates to the use of a laminated glazing as described hereinbefore as a side window or windshield of a motor vehicle or as a building window for damping vibrations and/or increasing loss of noise transmission, in particular of airborne origin, in the audible frequency decade between 1 kHz and 10 kHz, at room temperature. In the case where the glazed unit according to the invention is used as a windscreen, it of course meets all the conditions of United Nations Regulation 43 (referred to as Regulation R43) of resistance to strong impacts to ensure its mechanical strength. Additionally, the other glazing according to the invention has further improved acoustic insulation properties, and good mechanical properties due to the special choice of the interlayer (3) according to the invention.

### Characterization of the Mechanical Properties of Laminated Glazing

A laminated glazing according to the invention is prepared comprising:
an inner glass sheet having a thickness of 2.1 mm,
a viscoelastic outer layer having a thickness of 0.38 mm and comprising ethylene-carboxylic acid copolymer-based ionomers,
a viscoelastic damping adhesive inner layer having a thickness of 25 μm; said inner layer comprising two types of acrylic polymers, formed from 2-ethylhexyl acrylate and isobutyl acrylate, and a tackifier such as ARAKAWA®TFE20-011 and a plasticizer such as Alberdingk®EP 123545 K,
a viscoelastic outer layer having a thickness of 0.38 mm and comprising ethylene-carboxylic acid copolymer-based ionomers,
an outer glass sheet having a thickness of 2.1 mm.

A laminated glazing according to the prior art (called “Acoustic PVB”) consisting of two glass sheets with a thickness of 2.1 mm, said glazing being laminated using a three-layer viscoelastic interlayer comprising two outer layers of PVB and an inner layer with a thickness equal to 0.10 mm comprising PVB and plasticizers.

The above-mentioned laminated glazing is then subjected to a shear modulus measurement (in Pa); this value characterizes the stiffness of the interlayer and consequently the acoustic performance thereof.

Shear modulus is measured by DMTA using standard EN 16613 (in-plane shear method)

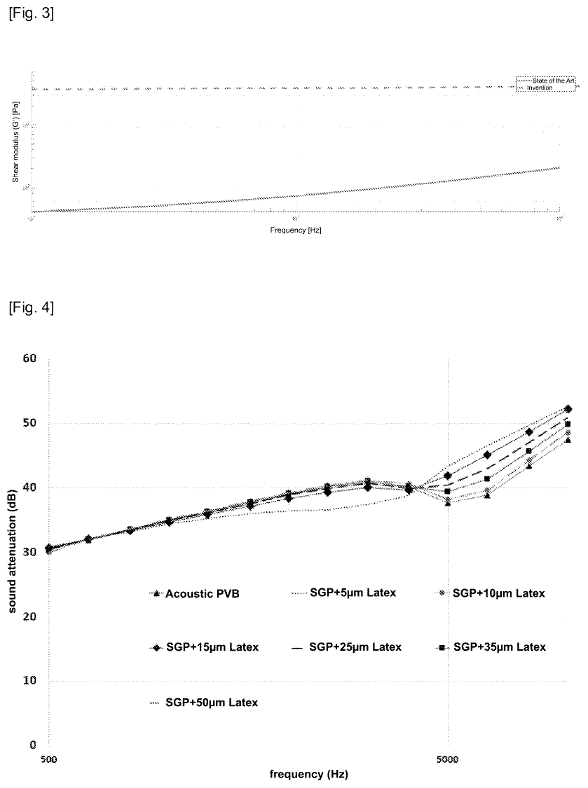

Thus FIG. 3—FIG. 3 shows shear modulus measurements of the laminated glazing according to the invention and of the laminated glazing according to the prior art in a frequency range between 100 Hz and 10,000 Hz.

The curve formed by a continuous line shows the shear modulus of the laminated glazing according to the prior art, while the curve formed by dashed lines shows the shear modulus of the laminated glazing according to the invention.

The results reported in FIG. 3 show that a laminated glazing according to the invention has better mechanical properties compared to a laminated glazing according to the prior art, since the shear modulus of the interlayer according to the invention is approximately 100 times greater than that obtained for the PVB interlayer with the prior art.

### Acoustic Characterization of Laminated Glazing

In order to show the acoustic gain obtained between a laminated glazing according to the invention, a laminated glazing according to the prior art and other laminated glazings outside the invention (comparatives), a digital simulation was carried out. The acoustic model is based on the finite element method so as to reproduce the acoustic attenuation behavior according to NF EN ISO 10140.

Thus, FIG. 4—FIG. 4 shows the acoustic attenuation of laminated glazing of different configurations subjected to airborne noise produced according to standard NF EN 10140.
The curve formed by a continuous line with triangles shows the acoustic attenuation of a glazing according to the prior art consisting of two glass sheets with a thickness of 2.1 mm, said glazing being laminated using a three-layer viscoelastic interlayer comprising two outer layers of PVB and an inner layer with a thickness equal to 0.15 mm comprising PVB and plasticizers (known as “Acoustic PVB”).
The curves formed respectively by dashed lines with dotted lines (called “SGP +5 μm latex”), by a continuous line with dots (called “SGP +10 μm latex”), by a continuous line with squares (called “SGP +35 μm latex”) and by a continuous line (called “SGP +50 μm latex”) show the acoustic attenuation of laminated glazing not covered by the invention (comparative examples). Said laminated glazing consists of a viscoelastic damping adhesive inner layer comprising two types of acrylic polymers, formed from 2-ethylhexyl acrylate and isobutyl acrylate and comprising as a tackifier: ARAKAWA®TFE20-011 and as plasticizer: Alberdingk®EP 123545 K. Said inner layer respectively has a thickness of 5 μm, 10 μm, 35 μm and 50 μm and is located between two viscoelastic outer layers having a thickness of 0.38 mm and comprising ethylene-carboxylic acid copolymer-based ionomers. Said outer layers are themselves located between two glass sheets with a thickness equal to 2.1 mm.
The curves formed respectively by a continuous line with diamonds (called “SGP +15 μm latex”), and by dashed lines (called “SGP +25 μm latex”) show the acoustic attenuation of the laminated glazing according to the invention. Said laminated glazing consists of a viscoelastic damping adhesive inner layer comprising two types of acrylic polymers, formed from 2-ethylhexyl acrylate and isobutyl acrylate and comprising as a tackifier: ARAKAWA®TFE20-011 and as plasticizer: Alberdingk®EP 123545 K. Said inner layer respectively has a thickness of 15 μm and 25 μm and is located between two viscoelastic outer layers having a thickness of 0.38 mm and comprising ethylene-carboxylic acid copolymer-based ionomers. Said outer layers are located between two glass sheets with a thickness equal to 2.1 mm.

The results reported in FIG. 4 show:
an improvement of at least 2.7 dB in the airborne acoustic attenuation of the laminated glazing according to the invention over all frequencies from 5000 Hz to 10000 Hz, at room temperature, compared with laminated glazing according to the prior art (acoustic PVB), and
an improvement of at least 1.0 dB in the airborne acoustic attenuation of the laminated glazing according to the invention over all frequencies from 5000 Hz to 10,000 Hz, at room temperature, compared with laminated glazing whose viscoelastic damping adhesive inner layer, arranged between the two ethylene-carboxylic acid copolymer outer layers, has a thickness outside the range between 15 μm and 25 μm (that is, having a thickness equal to 5 μm, 10 μm, 35 μm or 50 μm).

Thus a laminated glazing according to the invention therefore has both good acoustic properties and good mechanical properties.

1. A laminated glazing comprising an inner glass sheet and an outer glass sheet, each comprising an inner face and an outer face, and comprising, between the inner faces of the inner and outer glass sheets, an interlayer, said interlayer comprising:
at least two viscoelastic outer layers and having a thickness of between 0.1 mm and 0.8 mm, each of the at least two viscoelastic outer layers being in direct contact with one of the inner and outer glass sheets and being formed by a material comprising at least one ethylene-carboxylic acid copolymer-based ionomer, and
a viscoelastic damping adhesive inner layer arranged between the at least two viscoelastic outer layers, and said viscoelastic damping adhesive layer having a thickness of between 15 μm and 25 μm and being formed by a material comprising at least one acrylic polymer, at least one tackifier and at least one plasticizer.

2. The laminated glazing according to claim 1, wherein the at least one ethylene-carboxylic acid copolymer-based ionomer is one or more copolymer(s) comprising at least one ethylene monomer and at least one α-β-unsaturated carboxylic acid monomer, and 1% to 100% of the acid groups of said copolymer(s) being neutralized to carboxylic acid salts comprising carboxylate ions and metal counterions.

3. The laminated glazing according to claim 1, wherein the material of the viscoelastic damping adhesive inner layer has a glass transition temperature of between −55° C. and 10° C.

4. The laminated glazing according to claim 1, wherein the material has a mass fraction of the at least one acrylic polymer in the viscoelastic damping adhesive inner layer of between 0.21 and 0.62.

5. The laminated glazing according to claim 1, wherein the material has a mass fraction of the at least one tackifier in the viscoelastic damping adhesive inner layer (6) of between 0.17 and 0.60.

6. The laminated glazing according to claim 1, wherein the at least one tackifier comprises a hydrogenated resin.

7. The laminated glazing according to claim 1, wherein the material has a mass fraction of the at least one plasticizer in the viscoelastic damping adhesive inner layer (6) of between 0.07 and 0.43.

8. The laminated glazing according to claim 1, wherein the at least one acrylic polymer is formed from monomers selected from the group formed by methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, pentyl acrylate, pentyl methacrylate, isoamyl acrylate, isoamyl methacrylate, hexyl acrylate, hexyl methacrylate, cyclohexyl acrylate, cyclohexyl methacrylate, octyl acrylate, octyl methacrylate, isooctyl acrylate, isooctyl methacrylate, nonyl acrylate, nonyl methacrylate, isononyl methacrylate, isobornyl methacrylate, decyl acrylate, decyl methacrylate, dodecyl acrylate, dodecyl methacrylate, tridecyl acrylate, tridecyl methacrylate, hexadecyl acrylate, hexadecyl methacrylate, octadecyl acrylate, octadecyl methacrylate, 2-ethylhexyl acrylate, 2-ethylhexyl methacrylate, vinyl formate, vinyl acetate, vinyl propionate, 2-hydroxyethyl acrylate, hydroxyethyl methacrylate, 2-hydroxypropyl acrylate, 2-hydroxypropyl methacrylate, acrylic acid, styrene and acrylonitrile.

9. The laminated glazing according to claim 1, wherein the material comprises a first acrylic polymer having a first glass transition temperature, Tg₁, and a second polymer having a second glass transition temperature Tg₂, higher than Tg₁.

10. The laminated glazing according to claim 1, wherein the inner glass sheet and the outer glass sheet have a thickness of between 0.5 mm and 12 mm.

11. The laminated glazing according to claim 1, wherein the interlayer further comprises two films and made from a material selected from poly(ethylene vinyl acetate) (EVA) and poly(ethylene terephthalate) (PET) and mixtures thereof, each of the two films being arranged between the viscoelastic damping adhesive inner layer and one of the two viscoelastic outer layers.

12. The laminated glazing according to claim 11, wherein the two films and are in direct contact with the viscoelastic damping adhesive inner layer.

13. The laminated glazing according to claim 12, wherein each of the two films and has a thickness of between 6 um and 200 um

14. A side window or windshield of a vehicle comprising a laminated glazing according to claim 1.

15. A method comprising providing a laminated glazing according to claim 1 as a side window or windshield of a motor vehicle or as a building glazing.

16. A method for manufacturing a laminated glazing according to claim 1 comprising:
a) providing an inner glass sheet and an outer glass sheet
b) arranging between the inner faces of the inner and outer glass sheets an interlayer comprising:
a first viscoelastic layer formed by a material comprising at least one ethylene-carboxylic acid copolymer-based ionomer and having a thickness of between 0.1 mm and 0.8 mm,
a viscoelastic damping adhesive layer formed by a material comprising at least one acrylic polymer, at least one tackifier and having a thickness of between 15 μm and 25 μm, and
a second viscoelastic layer formed by a material comprising at least one ethylene-carboxylic acid copolymer-based ionomer and having a thickness of between 0.1 mm and 0.8 mm,
c) assembling the inner and outer glass sheets and the interlayer by lamination to form a laminated glazing, and
d) degassing by autoclaving said laminated glazing.

17. The laminated glazing according to claim 4, wherein the material has a mass fraction of the at least one acrylic polymer in the viscoelastic damping adhesive inner layer of between 0.21 and 0.51.

18. The laminated glazing according to claim 5, wherein the material has a mass fraction of the at least one tackifier in the viscoelastic damping adhesive inner layer of between 0.22 and 0.35.

19. The laminated glazing according to claim 6, wherein the tackifier comprises a hydrogenated rosin resin.

20. The laminated glazing according to claim 9, wherein the difference between the second glass transition temperature, Tg₂ and between the first glass transition temperature Tg₁ is greater than 10° C.
